(19) United States
(12) Patent Application Publication
(10) Pub. No.: US 2026/0205357 A1
(43) Pub. Date: Jul. 16, 2026

(54) Method for managing network slices in a telecommunications network

(71) Applicant: ORANGE, ISSY LES MOULINEAUX (FR)

(72) Inventor: Eric SCHOULER, Chatillon (FR)

(21) Appl. No.: 19/136,647

(22) PCT Filed: Dec. 5, 2023
(86) PCT No.: PCT/EP2023/084390

§ 371 Date: Jun. 6, 2025

(30) Foreign Application Priority Data
Dec. 6, 2022 (FR) FR2212819

(51) Int. Cl. H04L 41/084; H04L 41/40

(52) U.S. Cl. CPC H04L 41/0846; H04L 41/40

(57) ABSTRACT

A method for managing network slices in a telecommunications network including a management entity which is in charge of orchestrating virtualised network functions forming the network slices of the network. The method includes the following, executed by the management entity: from an identifier of an existing first network slice, selecting a set of virtualised network functions which belong to the first network slice; and creating a new network slice including the previously selected virtualised network functions which belong to the first network slice and including other network functions.

### CROSS-REFERENCE TO RELATED APPLICATIONS

This Application is a Section 371 National Stage Application of International Application No. PCT/EP2023/084390, filed Dec. 5, 2023, and published as WO 2024/121175 A1 on Jun. 13, 2024, not in English, which claims priority to and the benefit of French Patent Application No. 2212819, filed Dec. 6, 2022, the contents of which are incorporated herein by reference in their entireties.

### TECHNICAL FIELD

The technical field is that of telecommunications.

More precisely, the invention relates to a method for managing the creation of network slices in a telecommunications network.

5G networks (abbreviation for fifth-generation mobile telecommunications networks) introduce the concept of network slices. This concept is based on the virtualization of network functions. A virtual network function (abbreviated to VNF or VNFs in the plural) is a computer application that implements an expected function of a computer network or telecommunications network, such a function being for example a directory service or routing service or another service. In a 5G network, unlike previous generations of telecommunications networks, all network functions are virtualized, that is to say the functions required for the network to operate are rendered by computer programs running in virtual machines or similar technologies such as containers. This architectural design principle of new and future telecommunications networks is concretized by a framework standardized by the ETSI (European Telecommunications Standard Institute), a framework called NFV (Network Function Virtualization), ETSI defining the implementation thereof in its ISG NFV (Industry Specification Group—Network Function Virtualization) working group. This is in contrast to telecommunications networks of previous generations in which, in general, the network functions were attached to dedicated hardware equipment, such as exchanges, routers and base stations. In a 5G network, a set of hardware resources is available at several locations required to carry out network functions, but no function is attached to a given hardware element. This concept of virtualization of network functions, which originally appeared in the context of mobile telecommunications networks, may be applied in any type of network, including those in which access is fixed.

The virtualization of network functions in a 5G network makes it possible to implement the concept of network slices by distributing the network functions over hardware resources that will have been selected and reserved beforehand. The set of operations for managing a network slice is referred to as orchestration. Orchestration is carried out by an entity called an orchestrator, which will select and reserve hardware resources; start and stop virtual network function (VNF) instances using the reserved hardware resources; create relationships between VNFs so as to allow them to communicate with one another and delete these relationships if necessary; and make available access points for managing VNFs, for example for stopping them, restarting them, changing their relationships, duplicating them, or any other management operation. The creation of a network slice is therefore also a specific orchestration operation.

A network slice is defined in relation to a public land mobile network (PLMN). Such a public land mobile network is a mobile telecommunications network that exists in a given country and that provides a user terminal (or user equipment, abbreviated to UE) with physical access to telecommunications by way of antennas, base stations and any other necessary equipment. Once physical access to the telecommunications network has been guaranteed by the PLMN, it will be possible for a user terminal to access one or more network slices, once they have been created, using the access provided by the PLMN. It is conceivable for access to a network slice to be rendered by a non-mobile access network, and the concepts will remain similar.

A network slice is an instantiation of all virtual network functions (VNFs). Once the slice has been created, this being the result of an orchestration operation, the virtual network functions are instantiated and allow the network slice to take on all of the functions of a telecommunications network. In other words, a network slice is a virtual telecommunications network that runs in relation to a public land mobile network that provides physical access for the terminals to the network, a public land mobile network being able to provide access to multiple network slices.

The 3GPP TS 23.501 standard (Security architecture and procedures for 5G System) specifies these concepts and provides more detail.

The invention relates to the creation of a network slice in a telecommunications network, generally a 5G or subsequent generation telecommunications network.

### Prior Art

As has been seen, a network slice is defined, for example in accordance with the 3GPP TS 23.501 standard, in relation to a public land mobile network.

In particular, a network slice is identified by an identifier called the S-NSSAI (acronym for Single Network Slice Selection Assistance Information). This identifier comprises a first value called SST (acronym for Slice/Service Type), which is a reference for the expected behavior of the network slice in terms of functionalities and services, and an optional value called SD (acronym for Slice Differentiator), which encodes optional information for differentiating multiple network slices of the same SST type. The 3GPP TS 23.501 standard defines standard SST values, namely:
The eMBB (enhanced Mobile Broadband) type, with a value of 1, for enhanced mobile communication services.
The URLLC (Ultra-Reliable Low Latency Communication) type, with a value of 2, for low-latency communication services.
The MIoT (Massive Internet of Things) type, with a value of 3, for Internet of Things services.
The V2X type, with a value of 4, for connected vehicle services.

The 3GPP TS 23.501 standard stipulates that a user terminal UE may store at most sixteen S-NSSAI identifiers and the associated definitions of sixteen network slices in a dedicated memory area.

A terminal UE also comprises one or more SIM (Subscriber Identity Module) cards. These one or more SIM cards securely contain the information allowing the terminal UE to attach itself to one or more public land mobile networks PLMN. A SIM card is traditionally a physical object produced using chip card techniques. Its function may also be rendered by a chip integrated directly into the terminal UE, and it is then referred to as an eSIM (acronym for embedded SIM), but this variant does not interfere with the invention, and reference will be made hereinafter only to a SIM card. To simplify the description, it will be considered hereinafter that a user terminal UE contains only one SIM card and that this given SIM card contains the information allowing the terminal UE to attach to a given mobile network PLMN.

The given SIM card of the terminal UE is able to use one or more of the definitions stored in the dedicated memory area of the user terminal UE; at most sixteen S-NSSAI identifiers and associated slice definitions are accessible at present, and the terminal UE will be able to activate at most eight identifiers and slices out of the sixteen. The user terminal UE will access these eight slices via the public land mobile network PLMN, the access information for which is hosted in the SIM card in question. These eight slices must therefore be related to the public land mobile network PLMN because physical access to the network, and therefore to the slices, is that enabled by the SIM card, and therefore access to the network PLMN.

A user terminal UE that comprises a single SIM card will therefore be able, at a given time, to be attached to multiple network slices (at most eight). One use case may be for example a user terminal UE provided to an employee by a company. A first network slice will give access to the Internet, for example, and a second slice will correspond to the employee's corporate network. Various applications hosted in the terminal UE will then use different network slices; the Web browser will use the Internet slice, while a business application will use the corporate network slice. It is conceivable for there to be extra additions: the user may for example wish to purchase a network slice dedicated to gaming, with specific capacities, such as low latency, and will purchase access to a third dedicated slice, different from the general Internet access slice; the user may exercise high-level responsibilities, and their company may provide them with access to a specific slice with additional security functions. These four slices will be accessed by separate applications, depending on the user's uses. Use rules will be sent from the 5G network to the terminal UE to define this assignment of the applications to the slices, this corresponding to a routing policy called URSP (acronym for User equipment Route Selection Policy).

These four slices are accessed by a single public land mobile network PLMN, which is the one to which the SIM card of the terminal UE gives access. This means that virtual network functions VNFs necessarily have to be shared between the various slices accessed by one and the same terminal UE. These are for example the AMF (acronym for Access and Mobility management Function) and UDR (acronym for Unified Data Repository) functions, but other network functions VNFs may come into question. When it is stated that virtual functions VNFs are shared between various network slices, this is understood to mean that, for these functions, the various slices use a single instance of the function for a given location covered by the public mobile network PLMN, this instance having been created during the orchestration of one of the network slices that share it. At another location, another instance of the function may be used, but must be unique and shared between the slices. In the case of an access network not using a SIM card, it is conceivable for functions taking on a role similar to those seen above also to have to have a unique instance shared between the slices accessed by the same access network.

The GSMA NG 116 standard, for its part, describes the attributes exchanged between various entities to characterize a network slice, and in particular describes a generic network slice model, called GST (acronym for Generic network Slice Template). GST comprises optional or mandatory attributes that make it possible to describe the expected functionalities and performance of a network slice, but without detailing the network functions that are instantiated in a given network slice.

The entities that interact during the creation of a network slice are as follows:
A communication service customer (CSC). A CSC may be a user equipped with a terminal UE, but also a company that requires a corporate network, or any other entity that requires communication services.
A communication service provider (CSP). A CSP is the entity that sells the CSC the communication services that it requires. For this purpose, it will offer its customer CSC an offering containing products corresponding to the services sold in a given offering. These products run in a network slice tailored to their requirements. In one and the same offering, multiple slices may be used depending on the respective requirements of each product. Picking up on the previous example, a CSP will be able to offer a company a communication service offering using which the company's employees will be able to access, in one and the same terminal, a slice giving them access to the Internet for their private uses, on the one hand, and a slice corresponding to their corporate network, on the other hand, and to do so for example with performance that is adapted and differentiated between the two slices.
A network slice provider (NSP). An NSP is the entity that provides the CSP with a network slice according to its requests.
A mobile network operator (NOP, acronym for network operator). The network slice is defined in relation to a public land mobile network (PLMN). The NOP is the entity that will orchestrate the creation of the network slice, that is to say reserve the necessary hardware resources, instantiate the virtual network functions VNFs on these resources and create the links between VNF instances. The NOP may also be the mobile network operator PLMN or, at least, it possesses rights that enable it to ensure that the network slice that is created will be accessible via the PLMN. In addition to defining and creating the network slice in the form of virtual network function instances, the NOP will also define the access means that will allow user terminals UE to access the network slice and also the access means that will allow the CSP to manipulate the slice for its requirements, for example by provisioning new subscribers to the communication service provided by the CSP or by retrieving information useful for billing this same service.

These various roles may be taken on by separate actors, or else be taken on by a single entity. For example, a communication service provider CSP may also be a network slice provider NSP, and the CSP will then provide the communication service customer CSC with a network slice provided by the CSP to meet the communication service requirements of the customer CSC. Similarly, a network slice provider NSP may also be a mobile network operator NOP, and the mobile network slice that it will provide will quite simply be a network slice related to the mobile network PLMN, which is operated by itself as mobile network operator NOP.

The exchanges provided by current solutions, for example those defined in the GSMA NG 116 standard, between these various entities to result in the creation of a network slice are limited to functional or quality of service requests, but do not make it possible to specify precisely the virtualized network functions that will be instantiated for a given network slice. Moreover, as has already been seen, some network functions, related for example to the management of the data of the SIM card for attaching to the network PLMN, must be unique for a given user terminal UE among the various network slices that it is able to manage since, for a given SIM card, the user terminal UE will be able to access the various network slices via a single mobile network PLMN. There may be other constraints concerning whether or not network functions are shared between various network slices, but these are not taken into account in the current generic network slice template GST.

Given its constraints concerning the network functions expected for operating a network slice and for ensuring the operation of 5G networks, and in view of the a priori low number of network slices expected, the implementation choice made by network operators NOP consists in predefining possible network slices that are fixed once and for all, for example for the four predefined S-NSSAI values specified in the 3GPP TS 23.501 standard. A user terminal UE will then have a default S-NSSAI, generally the one corresponding to the value 1, that is to say the eMBB type, and either will not change it during operation thereof or will change it in order to attach to one of the network slices predefined in advance by the NOP.

This situation has a clear drawback.

In the current situation, network slices are defined once and for all and cannot evolve. Now, it may be advantageous to change provider for some virtualized network functions of a network slice while at the same time keeping the others, for example following calls to tender for specific services. These changes must be made taking into account the fact that some network functions (virtualized ones here) must remain the same for all possible network slices of a user terminal UE using one and the same SIM (this being the general case), that is to say these various slices must share a single instance for each of these virtualized network functions. Known solutions for specifying the creation of network slices do not make it possible to take these constraints into account, since they are limited to describing functional requirements. As a result, network slices are predefined once and for all by network operators NOP. The capacity for dynamism and evolution as promised by the evolution to a 5G telecommunications network are therefore not yet accessible.

Moreover, the current situation in which network slices are predefined once and for all corresponds to a situation in which mobile network operators NOP are located throughout the value chain, that is to say are also slice providers NSP and communication service providers CSP. In this situation, the mobile network operator NOP, which is also communication service provider CSP, faced with a request from a communication service customer CSC expressed in terms of expected functionalities and quality of service, will respond with a service that relies on one of the network slices that it has already predefined. This is not a problem for the NOP, which also takes on the roles of CSP and NSP, but this hinders the possibility of having other economic actors who could take on the roles of communication service provider CSP or network slice provider NSP independently of the mobile network operator NOP. Indeed, these new parties would, at present, be limited to offering network slices that are predefined by the mobile network operator NOP and therefore cannot be differentiated or offer innovative combinations of virtualized network functions.

The invention aims to improve the situation.

### The Invention

According to a first functional aspect, the invention relates to a method for managing the creation of network slices in a telecommunications network comprising a management entity responsible for orchestrating virtualized network functions forming the network slices of the network, characterized in that the method comprises the following steps, carried out by said management entity:
Based on an identifier of a pre-existing first network slice, selecting a set of virtualized network functions belonging to the first network slice
Creating a new network slice comprising the previously selected virtualized network functions belonging to the first network slice and comprising other virtualized network functions

By virtue of the invention, network slices are created dynamically. The creation is carried out by the management entity responsible for orchestrating the virtualized network functions forming the network slices, since this is indeed an orchestration operation, the first for a given slice. This entity will most often be the operator of the telecommunications network containing the created network slices, and will be called NOP, for network operator. By virtue of the invention, contrary to the current situation, the network slices are not defined a priori. A slice is created based on a pre-existing slice, which is known by its identifier. A certain number of virtualized network functions used by the existing slice will also be used by the created slice. In this way, constraints relating to the sharing of network functions, those relating to the SIM for example, or others, will be complied with during the creation of the new slice.

According to a first particular mode of implementation of the invention, the method comprises the following additional steps carried out by the management entity responsible for orchestrating virtualized network functions forming the network slices:
Receiving, from a second management entity responsible for providing network slices, a request to create a new network slice, the request comprising an identifier of a pre-existing first network slice
Defining at least one description of a network slice, said at least one description referring to the virtualized network functions selected based on the identifier belonging to the pre-existing first slice
Transmitting, to the management entity responsible for providing network slices, a set of previously defined descriptions of network slices
Receiving, from the management entity responsible for providing network slices, a datum representative of a choice relating to the creation of the new network slice

By virtue of this first mode, a new network slice is created upon request of the entity responsible for providing a network slice. This entity will be called NSP, for Network Slice Provider. The invention makes it possible to clearly distinguish the roles between multiple management entities so as, in this case too, to ensure dynamicity in terms of the creation of the network slices, and to prevent the network slices from being defined once and for all by the network operator NOP. The entity responsible for orchestration NOP receives, from the entity responsible for providing a slice NSP, the request to create a new slice, and the identifier of a pre-existing slice. The entity NOP will then define descriptions of slices that may be created, taking into account the virtualized network functions of the first slice that are to be shared, and submit these descriptions to the entity NSP, which will return the choice of the slice to be created. A network slice is therefore actually created by the entity responsible for orchestration, but upon request of the entity that will ultimately provide this created slice.

According to a second functional aspect, the invention relates to a method for managing the creation of network slices in a telecommunications network comprising a management entity responsible for providing network slices, characterized in that the method comprises the following steps, carried out by said management entity:
Receiving, from a management entity responsible for providing communication services, a request to create a new network slice, the request comprising an identifier of a pre-existing first network slice
Transmitting said creation request to a management entity responsible for orchestrating virtualized network functions
Receiving, from said management entity responsible for orchestrating virtualized network functions, a set of descriptions of network slices
Transmitting said set to the management entity responsible for providing communication services
Receiving, from the management entity responsible for providing communication services, a datum representative of a choice relating to the creation of the new network slice
Transmitting said datum to the management entity responsible for orchestrating virtualized network functions

In this functional aspect, the management entity responsible for providing network slices receives, from a management entity responsible for providing communication services, a request to create a new network slice, also called a second network slice, the request comprising an identifier of a pre-existing first network slice, so that the new created network slice comprises virtualized network functions belonging to the first network slice. These virtualized network functions belonging to the first network slice will be selected by the management entity responsible for orchestrating the virtualized network functions. The fact that the request to create the second network slice comprises the identifier of a first network slice will make it possible, when the second slice is actually created, to retrieve virtual network functions that are present in the first slice and that are to be reused by the second slice and to select these virtual network functions that are present in the first slice and that are to be included in the second slice. This functional aspect therefore makes it possible to construct a new network slice, also called a second network slice, based on a pre-existing first slice and by using functions of the first slice in the second slice.

By virtue of this aspect of the invention, all of the possible roles potentially involved in the creation of a network slice are well defined, and their collaboration is specified. It is the entity responsible for providing a communication service, which will be called CSP (communication service provider), that will initiate requesting of the creation of a new slice. This request is made to the entity NSP, which provides the entity CSP with the one or more network slices that it needs to provide a communication service to its one or more customers. This request is made with reference to a pre-existing network slice to which the entity CSP already has access and that is already provided by the entity NSP. The entity NSP transmits the request to the entity NOP responsible for orchestrating the network slices and that will therefore ultimately create the requested slice. The identifier of the pre-existing network slice must be transmitted to the entity NOP, since this will make it possible to inform the proposal of descriptions of network slices that will be able to be created. The entity NSP transmits all of the descriptions of the network slices that will be able to be created to the entity CSP, and then receives the choice that is made and transmits it. The advantage of this aspect of the invention is therefore that of enabling collaboration between three entities CSP, NSP and NOP to achieve the dynamic creation of network slices, satisfying the request of an entity providing a communication service. This collaboration, which is made possible by the invention, makes it possible to separate the various roles contributing to the creation of a network slice between various entities, rather than having a monolithic organization in which the network operator creates the network slices once and for all and provides them to its customers.

According to a first mode of implementation of this second aspect of the invention, the management entity responsible for providing network slices makes a choice from the set of descriptions of network slices received from the management entity responsible for orchestrating virtualized network functions and then transmits the chosen subset of descriptions of network slices from the set of descriptions to the management entity responsible for providing communication services.

By virtue of this first mode, the management entity NSP responsible for providing a network slice contributes to the choice of the network slice to be created by selecting one or more descriptions of network slices from the descriptions proposed by the management entity NOP responsible for orchestration. The benefit of this mode is that of ensuring that the entity responsible for providing network slices is able to intervene in the choice of the network slice to be created, even if the final choice is left to the entity CSP responsible for providing the communication service, which is the customer of the management entity NSP. In separating the roles between the three entities CSP, NSP and NOP, this mode allows the entity NSP to incorporate its constraints and preferences, this being natural since the entity NSP is responsible for providing the network slice that will be created.

According to a third functional aspect, the invention relates to a method for managing the creation of network slices in a telecommunications network comprising a management entity responsible for providing communication services, characterized in that the method comprises the following steps, carried out by said management entity:
Transmitting, to a management entity responsible for providing network slices, a request to create a new network slice, the request comprising an identifier of a pre-existing first network slice
Receiving, from the management entity responsible for providing network slices, a set of descriptions of network slices
Choosing, from the previously received set of descriptions of network slices, the description of a network slice to be created
Transmitting, to the management entity responsible for providing network slices, a datum representative of a choice relating to the creation of the new network slice

By virtue of this aspect of the invention, it is the management entity CSP responsible for providing a communication service that initiates requesting of the creation of a new network slice. This request is made taking into account a pre-existing network slice to which the entity CSP already has access. This new network slice will be able to be used by the entity CSP to provide a new communication service or else to improve its current offerings. By virtue of this aspect of the invention, the management entity CSP chooses the new slice that it wishes to use from the slice descriptions proposed thereto. The entity CSP transmits the result of its choice to the entity NSP. The advantage of the invention is that of making it possible to dynamically obtain new network slices, according to the requirements of the entity responsible for providing the communication services, without it being constrained to slices predefined by the network operator.

According to one mode of implementation of the third aspect of the invention, the management entity responsible for providing a communication service transmits, to the management entity responsible for providing a network slice, in relation to the request to create a new network slice comprising the identifier of a pre-existing first network slice, information relating to the expected functionalities of the new network slice, said information comprising quality of service parameters and indications relating to the sharing of virtual network functions between the pre-existing network slice and the new network slice.

According to one mode of implementation of the second aspect of the invention, the management entity responsible for providing a network slice receives, from the management entity responsible for providing a communication service, in relation to the request to create a new network slice comprising the identifier of a pre-existing first network slice, information relating to the expected functionalities of the new network slice, said information comprising quality of service parameters and indications relating to the sharing of virtual network functions between the pre-existing network slice and the new network slice, and the management entity responsible for providing a network slice transmits, to the management entity responsible for orchestrating virtualized network functions, said received information in addition to the request to create a new network slice comprising the identifier.

According to one mode of implementation of the first aspect of the invention, the management entity responsible for orchestrating virtualized network functions receives, from the management entity responsible for providing a network slice, in relation to the request to create a new network slice comprising the identifier of a pre-existing network slice, information relating to the expected functionalities of the new network slice, said information comprising quality of service parameters and indications relating to the sharing of virtual network functions between the pre-existing network slice and the new network slice, and the management entity responsible for orchestrating virtualized network functions selects a set of virtualized network functions belonging to the first network slice and defines descriptions of network slices taking into account said received information.

By virtue of these three modes of implementation of the invention, the creation of a new network slice takes into account information relating to the expected functionalities of the new network slice. This information comprises quality of service parameters, on the one hand, and indications relating to the sharing of virtual network functions, on the other hand. It is the entity CSP responsible for providing a communication service that first provides this information to the entity NSP responsible for providing the network slice, which will itself provide said information to the entity NOP responsible for orchestrating the virtual functions and therefore for creating the slice. The descriptions of network slices proposed by the entity NOP therefore take this information into account. The entity CSP may therefore enrich a request to create a new network slice with information relating to its wishes regarding the new slice. These wishes concern firstly the expected quality of service of the new slice. These wishes then concern the sharing of virtual network functions between the first network slice, which is already used by the entity CSP, and the network slice to be created. By virtue of these modes of implementation, the creation of a new network slice is controlled by the entity responsible for providing the communication services and is dynamic, rather than being controlled by the network operator and being static, with slices predefined once and for all.

According to a first hardware aspect, the invention relates to a management entity responsible for orchestrating virtualized network functions forming the network slices of a telecommunications network, the entity implementing a method for managing the creation of network slices in the network, characterized in that the management entity comprises:
A reception module able to receive, from a second management entity responsible for providing network slices, a request to create a new network slice, the request comprising an identifier of a pre-existing first network slice
A selection module able to select, based on the identifier of the pre-existing first network slice, a set of virtualized network functions belonging to the pre-existing first network slice
A definition module able to define at least one description of a network slice, said at least one description referring to the virtualized network functions selected based on the identifier belonging to the pre-existing first network slice
A transmission module able to transmit, to the management entity responsible for providing network slices, a set of previously defined descriptions of network slices
A reception module able to receive, from the management entity responsible for providing network slices, a datum representative of a choice relating to the creation of the new network slice
A creation module able to create a new network slice comprising the previously selected virtualized network functions belonging to the first network slice and comprising other virtualized network functions

According to a second hardware aspect, the invention relates to a management entity responsible for providing network slices in a telecommunications network, the entity implementing a method for managing the creation of network slices in the network, characterized in that the management entity comprises:
A reception module able to receive, from a management entity responsible for providing communication services, a request to create a new network slice, the request comprising an identifier of a pre-existing first network slice
A transmission module able to transmit said creation request to a management entity responsible for orchestrating virtualized network functions
A reception module able to receive, from said management entity responsible for orchestrating virtualized network functions, a set of descriptions of network slices
A transmission module able to transmit said set to the management entity responsible for providing communication services
A reception module able to receive, from the management entity responsible for providing communication services, a datum representative of a choice relating to the creation of the new network slice
A transmission module able to transmit said datum to the management entity responsible for orchestrating virtualized network functions

According to a third hardware aspect, the invention relates to a management entity responsible for providing communication services in a telecommunications network, the entity implementing a method for managing the creation of network slices in the network, characterized in that the management entity comprises:
A transmission module able to transmit, to a management entity responsible for providing network slices, a request to create a new network slice, the request comprising an identifier of a pre-existing first network slice
A reception module able to receive, from the management entity responsible for providing network slices, a set of descriptions of network slices
A choosing module able to choose, from the previously received set of descriptions of network slices, the description of a network slice to be created
A transmission module able to transmit, to the management entity responsible for providing network slices, a datum representative of a choice relating to the creation of the new network slice

According to another hardware aspect, the invention relates to a computer program able to be implemented by a management entity responsible for orchestrating virtualized network functions forming the network slices of a telecommunications network, the program comprising code instructions that, when it is executed by a processor, carry out the steps of the method for managing the creation of network slices as defined above.

According to another hardware aspect, the invention relates to a computer program able to be implemented by a management entity responsible for providing network slices in a telecommunications network, the program comprising code instructions that, when it is executed by a processor, carry out the steps of the method for managing the creation of network slices as defined above.

According to another hardware aspect, the invention relates to a computer program able to be implemented by a management entity responsible for providing communication services in a telecommunications network, the program comprising code instructions that, when it is executed by a processor, carry out the steps of the method for managing the creation of network slices as defined above.

The computer programs in question may be written in any programming language. These may for example be compiled languages, or else interpreted languages, or else use a mixed mode of operation using compilation to a bytecode that will then be interpreted by a virtual machine. The programs may run on hardware architectures, or else in virtual machines, or else in similar technologies such as container systems.

Lastly, according to another hardware aspect, the invention relates to data media storing computer programs comprising sequences of instructions for implementing the management methods as defined above.

The data media may be any entity or device capable of storing the programs. For example, the media may comprise a storage means, such as a ROM, for example a CD-ROM or a microelectronic circuit ROM, or else a magnetic recording means such as a hard disk. On the other hand, the media may be transmissible media such as an electrical or optical signal, which may be routed via an electrical or optical cable, by radio or by other means. The programs according to the invention may in particular be downloaded from the Internet. As an alternative, the information medium may be an integrated circuit into which the program is incorporated, the circuit being designed to execute or to be used in the execution of the method in question.

### BRIEF DESCRIPTION OF THE DRAWING

The invention will be better understood on reading the following description, which is given by way of example and with reference to the appended drawing, in which:

FIG. 1 shows a telecommunications network and network slices, along with the management entities creating a network slice according to the invention.

### DETAILED DESCRIPTION OF ILLUSTRATIVE EMBODIMENTS

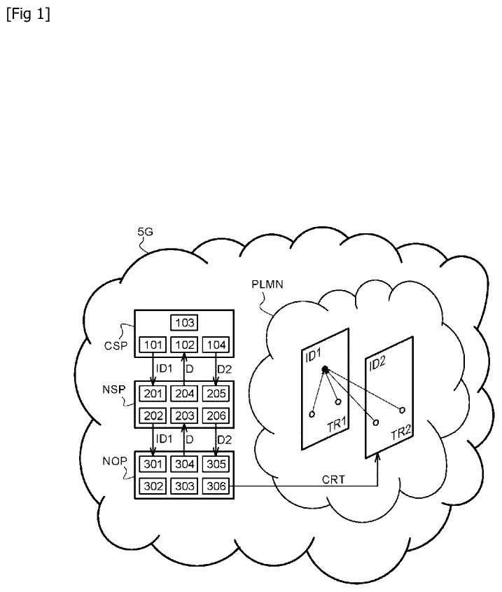

FIG. 1 shows a telecommunications network 5G. The term “5G” chosen for the figure refers, of course, to mobile telecommunications networks in accordance with the 5G standard, in which the concepts of virtualization of network functions and consequently network slices are introduced. However, the network 5G according to the invention may be any telecommunications network having network slices. It may be a mobile telecommunications network in accordance with the 5G standard or a subsequent standard, but also a telecommunications network access to which is fixed, provided that this network makes it possible to give access to network slices TR1, TR2, which are sets of virtual network function instances that are linked together and render all of the services of a telecommunications network.

FIG. 1 shows two network slices TR1 and TR2. These two slices TR1 and TR2 are identified by the identifiers ID1 and ID2, respectively. A public land mobile network PLMN gives access, in FIG. 1, to the two network slices TR1 and TR2, but other types of access network may be envisaged. The access network PLMN to the network slices TR1 and TR2 is not discussed any further below. The hardware resources on which the virtual network function instances constituting the network slices TR1, TR2 run are not specified any further below and are not shown in FIG. 1.

The telecommunications network 5G comprises three management entities, respectively called CSP, NSP and NOP, which implement methods for managing the creation of network slices according to the invention.

The management entities CSP, NSP and NOP are software components running on hardware computing resources. They comprise one or more computer programs that run on computer resources for managing the telecommunications network 5G. These programs may be programmed in any type of programming language. They may be monolithic or organized into distributed systems. They run on servers that are dedicated to each management entity or shared. The management entities CSP, NSP and NOP may for example be deployed in one or more cloud computing systems. The programs forming the management entities CSP, NSP and NOP may run directly on hardware resources, or else in virtual machines or in similar technologies such as containers. The three management entities CSP, NSP and NOP may be located together on the same hardware resources or else separated, and in that case they are connected to one another by communication links, not shown in FIG. 1, allowing them to exchange messages and requests in accordance with an unspecified protocol, for example Web requests, or remote procedure calls or any other suitable protocol.

The three management entities CSP, NSP and NOP may belong to one and the same operator and be operated thereby, or else, on the contrary, belong to different operators. Other combinations are possible, with one and the same operator operating for example the management entities NOP and NSP and a second operator operating the management entity CSP.

The management entity CSP is responsible for providing communication services in the telecommunications network 5G. In our example, the management entity CSP comprises the following modules.

The management entity CSP comprises a transmission module 101 able to transmit, to the management entity NSP, a request to create CRT a new network slice, the request comprising an identifier ID1 of a pre-existing first network slice TR1.

The management entity CSP comprises a reception module 102 able to receive, from the management entity NSP, a set D of descriptions of network slices.

The management entity CSP comprises a choosing module 103 able to choose, from the set D of descriptions of network slices received by the module 102 in the description, a network slice TR2 to be created.

The management entity CSP comprises a transmission module 104 able to transmit, to the management entity NSP, a datum D2 representative of a choice relating to the creation of the new network slice TR2.

The management entity NSP is responsible for providing network slices in the telecommunications network 5G. The management entity NSP comprises, in our example, a reception module 201 able to receive, from the management entity CSP, a request to create CRT a new network slice, the request comprising an identifier ID1 of a pre-existing first network slice TR1.

The management entity NSP comprises a transmission module 202 able to transmit, to the management entity NOP, the request to create CRT a new network slice, the request comprising an identifier ID1 of a pre-existing first network slice TR1.

The management entity NSP comprises a reception module 203 able to receive, from the management entity NOP, a set D of descriptions of network slices.

The management entity NSP comprises a transmission module 204 able to transmit, to the management entity CSP, the set D of descriptions of network slices.

The management entity NSP comprises a reception module 205 able to receive, from the management entity CSP, a datum D2 representative of a choice relating to the creation of the new network slice TR2.

The management entity NSP comprises a transmission module 206 able to transmit, to the management entity NOP, the datum D2 representative of a choice relating to the creation of the new network slice TR2.

The management entity NOP is responsible for orchestrating the virtualized network functions forming the network slices of the telecommunications network 5G. The management entity NOP comprises, in our example, a reception module 301 able to receive, from the management entity NSP, a request to create CRT a new network slice, the request comprising an identifier ID1 of a pre-existing first network slice TR1.

The management entity NOP comprises a selection module 302 able to select, based on the identifier ID1 of the pre-existing first network slice TR1, a set of virtualized network functions belonging to the pre-existing first network slice TR1.

The management entity NOP comprises a definition module 303 able to define at least one description of a network slice, said at least one description referring to the virtualized network functions selected based on the identifier ID1 belonging to the pre-existing first network slice TR1.

The management entity NOP comprises a transmission module 304 able to transmit, to the management entity NSP, a set D of previously defined descriptions of network slices.

The management entity NOP comprises a reception module 305 able to receive, from the management entity NSP, a datum D2 representative of a choice relating to the creation of the new network slice TR2.

The management entity NOP comprises a creation module 306 able to create CRT a new network slice TR2 comprising the previously selected virtualized network functions belonging to the first network slice TR1 and comprising other virtualized network functions.

FIG. 1 shows a single management entity CSP, a single management entity NSP, and a single management entity NOP in order to simplify the description of the invention, but the methods according to the invention may operate with multiple management entities NSP, CSP and NOP. Simply put, the communications defined in the management methods must be continued between the same entities once they have begun. For example, after a management entity CSP has asked a management entity NSP to create a network slice, the management entity CSP will receive a set D of descriptions of network slices from the same management entity NSP and will always have to transmit its choice D2 to the same management entity NSP.

The management entity CSP is responsible for providing communication services in the telecommunications network 5G. Such services may be for example Internet access services, telephony services, messaging services, data transfer services, connected object services, Internet television services, gaming access services or any other type of service and combination of services. These services may be intended for individuals or else companies or organizations in general. These services may have variable quality of service levels and likewise for security guarantees depending on the level of quality that the management entity CSP is able to offer and ensure to its customers.

The management entity CSP may be operated by the same organization as the one that operates the telecommunications network 5G, or else it may be operated by a different organization and in that case have a contractual relationship with the organization that operates the network 5G. In any case, the management entity CSP may utilize at least one network slice TR1 from the slices contained in the network 5G. It is by utilizing the functionalities of at least one network slice of the network 5G that the management entity CSP is able to provide one or more communication services to its customers or users of said services.

The triggering element in several modes of the management methods of the present patent application is a request to create a new network slice made by the management entity CSP. For the requirements of the communication services provided by the entity CSP, the latter may need to operate a new network slice in addition to or instead of the pre-existing network slice TR1 operated by the management entity CSP. For example, the network slice TR1 enables the management entity CSP to guarantee a certain quality of service to its customers, and, in order to offer a communication service with a better quality of service, the entity CSP will have to be able to have available a network slice other than the pre-existing slice TR1. This creation request CRT comprises the identifier ID1 of the pre-existing network slice TR1. This information will be used to create the requested new network slice TR2 because it will make it possible to take into account the constraints that exist regarding the sharing of virtualized network functions between network slices that have already been discussed. The management entity CSP transmits the request to create CRT a new slice TR2 to a management entity NSP.

The management entity NSP is responsible for providing network slices in the telecommunications network 5G. The management entity NSP gives one or more management entities CSP access to network slices so as to allow it or them to provide communication services. Like for the management entity CSP, the management entity NSP may be operated by the same organization as the one that operates the telecommunications network 5G, or else it may be operated by a different organization and in that case have a contractual relationship with the organization that operates the network 5G.

In several embodiments of the management methods according to the invention, the management entity NSP receives a request to create a new slice from the management entity CSP. This request contains the identifier ID1 of a pre-existing slice TR1, this identifier being able to be replaced by any other reference that makes it possible to retrieve the relevant information relating to the slice TR1. The slice TR1 is already provided by the entity NSP to the entity CSP and is used thereby to provide some of its communication services. The reference to the slice TR1 will make it possible to ensure that the respective constraints on the pre-existence of this slice TR1 will indeed be taken into account when the new slice is created. The management entity NSP transmits the received request to create a new slice to a management entity NOP.

The management entity NOP is responsible for orchestrating virtualized network functions in the telecommunications network 5G. As such, it is the management entity NOP that will effectively create CRT the requested new network slice. Indeed, the creation of a network slice, as already explained, comprises reserving hardware resources and activating virtual network function instances and communication links between these instances. This is therefore an operation of orchestrating the virtualized network functions of the telecommunications network 5G that results in the creation of a new network slice.

Like for the other management entities, the management entity NOP may be operated by the same organization as the one that operates the telecommunications network 5G, or else it may be operated by a different organization and in that case have a contractual relationship with the organization that operates the network 5G. In general, however, the management entity NOP is operated by the operator of the network 5G.

A 5G network may comprise a single management entity NOP responsible for orchestrating virtualized functions for all slices, but operation with multiple management entities NOP is also conceivable. For example, distinct management entities NOP may create and orchestrate network slices for distinct functional domains; one will handle network slices dedicated to telecommunications services, another will handle connected vehicle services, another will handle business services, etc. Other types of slicing are of course possible.

In some embodiments of the invention, the management entity NOP, based on an identifier ID1 of a pre-existing first network slice TR1, will select a set of virtualized network functions belonging to the first network slice TR1, and then create CRT a second network slice TR2 comprising the previously selected virtualized network functions belonging to the first network slice TR1 and comprising other virtualized functions. The identifier ID1 may, in several embodiments, be the one received in the request to create a new slice TR2 received by the management entity NOP. Selecting the functions consists, in most of the embodiments of the invention, in retaining the virtualized network functions that have to be shared between all of the network slices orchestrated by the management entity NOP. It has been seen for example that the functions relating to the management of the SIM card have to be shared so as to ensure that the public mobile network PLMN is able to access the slices. Other selection criteria may be applied. The new network slice TR2 will then be created CRT by the management entity NOP by taking over the virtualized network function instances selected previously in the slice TR1.

As indicated above, a network slice TR1, TR2 is an instantiation of all virtual network functions. In FIG. 1, the virtual function instances are represented by dots and circles inside TR1 and TR2. Relationships between instances, indicating data exchanges between instances for example, are represented by arrows. It may be seen in FIG. 1 that two virtual network function instances of TR2, represented by circles, are connected to one virtual network function instance of TR1, represented by a solid circle. This representation as a solid circle indicates that this virtual function instance is shared between the two slices TR1, TR2. In other words, the functionality of this network function is rendered, within the slice TR2, by a virtual network function instance of the slice TR1. The relationships between virtual network function instances within the slice TR2 must therefore partially include instances outside the slice TR2, this being indicated in FIG. 1 by two arrows “leaving” the network slice TR2.

The creation CRT of a network slice TR2 is an operation known as orchestration, which will comprise reserving hardware resources, instantiating virtual network functions on these hardware resources, establishing relationships between instances, assigning identifiers to the various instances, etc. The concepts of orchestration are well known in the prior art and are not detailed any further here. The subject of the present patent application is a set of methods preceding the creation CRT of the slice TR2 as such. FIG. 1 therefore shows the final state obtained following one exemplary embodiment of the methods of the present patent application, which exemplary embodiment results in the creation CRT of the network slice TR2, a virtual network function instance of which is shared with the slice TR1. The network slice TR1, for its part, is shown in FIG. 1 as pre-existing to the exemplary embodiment of the methods of the present patent application.

Once the slice TR2 has been created CRT, the virtual network functions are instantiated and allow the network slice TR2 to take on all of the functions of a telecommunications network. The virtual network functions of the network slice TR1 are for their part already instantiated, prior to the operation of creating CRT the network slice TR2. In other words, a network slice TR1, TR2 is a virtual telecommunications network that runs on hardware resources.

In other embodiments of the invention, other steps are interposed between selecting the virtualized network functions of the slice TR1 and creating CRT the new network slice TR2.

After the selection of virtualized network functions belonging to the first network slice TR1, in our example, the management entity NOP will define at least one description of a network slice. The set of descriptions of network slices thereby defined is called D in FIG. 1. A description of a network slice is a computer object that makes it possible to represent a network slice. This representation will then be able to be used in computer processing, and in particular will be able to allow the creation CRT of the described network slice, but will also be able to allow a choice or confirmation of the network slice to be created.

The description of a network slice will therefore comprise, for example, information relating to the reservation of hardware resources, to the functions used to instantiate virtualized network functions, to the establishment of communication links between virtualized network functions and, in general, any other information useful for the creation and operation of the described network slice. A description of a network slice may be seen as a configuration file for the computer object that is the network slice, or even as a build file in the sense of building a computer object. Other parameters, such as for example identifiers, quality of service parameters, use costs or any other parameter, may be present in a description of a network slice. A description of a network slice may for example be expressed in a language that makes it possible to express complex and structured data, such as XML (extensible Markup Language) or YAML (Yet Another Markup Language) or JSON (JavaScript Object Notation) or any other language, or in a mixture of these possibilities.

The descriptions of network slices defined by the management entity NOP may, in some embodiments, be based on predefined templates or models that leave open multiple definition options for specific network functions and limit others to a single choice. In this way, the management entity NOP does not have to make all of the choices required to create a network slice. Some may be predefined. The choosing step carried out by the management entity NOP, in these embodiments, exhibits both good dynamicity depending on the options that are left open, while at the same time having greater simplicity, which makes it easier to carry out the operation of defining the set D of descriptions for the management entity NOP.

The set D of descriptions of network slices defined by the management entity NOP represents the set of descriptions of the network slices that the management entity NOP is prepared to create CRT following receipt of a request to create CRT a new network slice TR2, said request comprising the identifier ID1 of a pre-existing first network slice TR1. In some embodiments of the invention, the management entity NOP will therefore transmit the set D of previously defined descriptions of network slices to the management entity NSP responsible for providing network slices.

The management entity NSP will therefore receive, in several embodiments of the invention, from the management entity NOP, the set D of descriptions of network slices. The management entity NSP will then transmit, to the management entity CSP, the previously received set D of descriptions of network slices. In several embodiments of the invention, this transmission by the management entity NSP is carried out without changing the previously received set D of descriptions of network slices.

The management entity CSP will therefore receive a set D of descriptions of network slices. This set D is received following the request to create a new network slice made by the management entity CSP, the request containing the identifier ID1 of a pre-existing first network slice TR1. The presence of the identifier ID1 has allowed the management entity NOP to select functions present in the slice TR1 that are to be shared, and the definition of the network slices that are grouped into the set D takes this selection into account. The creation of one of the network slices the description of which is present in the set D could therefore be in response to the request issued by the management entity CSP, which might subsequently use the created network slice to provide communication services.

The management entity CSP will therefore choose, from the received set D of descriptions, a description D2 of a network slice TR2 to be created. This choice may be informed by a whole set of data, for example relating to the cost of the proposed network slices, or to expected quality of service parameters, or to data concerning the location of virtualized network functions or to any other consideration. The choosing operation makes it possible to ensure that a network slice will be created in accordance with the requirements of the management entity CSP, which will then use the created network slice to provide communication services. The choice is made from descriptions of network slices able to be created that take into account the pre-existing network slice TR1. The invention therefore achieves both dynamicity in terms of the creation of network slices, rather than having a set of predefined network slices fixed by the 5G network operator, and taking into account of the constraints regarding sharing of instances of certain virtualized network functions between slices.

After this choice, in our example, the management entity CSP will transmit, to the management entity NSP, a datum D2 representative of a choice relating to the creation of the new network slice TR2.

In several embodiments of the invention, the management entity NSP will receive, from the management entity CSP, a datum D2 representative of a choice relating to the creation of the network slice TR2, and will then transmit, to the management entity NOP, the previously received datum D2 representative of a choice relating to the creation of the network slice TR2.

In these embodiments, the management entity NOP will therefore receive, from the management entity NSP, a datum D2 representative of a choice relating to the creation of the network slice TR2. The management entity NOP then creates CRT a second network slice TR2 comprising the previously selected virtualized network functions belonging to the first network slice TR1 and comprising other virtualized network functions.

The advantages of the methods according to the invention are therefore those of making it possible to create a network slice, and not making do with using network slices that are predefined once and for all. The methods according to the invention therefore provide dynamicity to the management of the network slices TR1, TR2 in the telecommunications network 5G. This creation is carried out upon request of a management entity CSP responsible for providing communication services in the network 5G, but it is implemented by the management entity NOP responsible for orchestrating the network slices TR1, TR2. The methods according to the invention therefore make it possible to better separate the roles between the various management entities contributing to the operation of the network slices TR1, TR2 and the communication services in the telecommunications network 5G. By virtue of selecting a set of virtualized network functions belonging to the first network slice TR1, the methods according to the invention have the advantage of enabling the dynamic creation of the network slice TR2 taking into account the constraints regarding sharing of the virtualized network function instances between the various slices TR1, TR2.

In other embodiments of the invention, the management entity CSP transmits, to the management entity NSP, in relation to the request to create CRT a new network slice comprising an identifier ID1 of a pre-existing first network slice TR1, information relating to the expected functionalities of the new network slice, said information comprising quality of service parameters and indications relating to the sharing of virtual network functions between the pre-existing network slice TR1 and the new network slice. The management entity NSP will receive this information in relation to the creation request CRT, and transmit it to the management entity NOP. The management entity NOP will receive this information in relation to the creation request CRT and use it firstly to select a set of virtualized network functions belonging to the first network slice TR1 and also to define a set D of descriptions of network slices.

For example, the information relating to the sharing of virtual network functions may indicate which function instances should be shared and which may not be shared. The information may also specify that virtualized network function instances should not be shared, that is to say the network slice the creation CRT of which is requested will have to have its own instance for this virtualized network function. These constraints relating to the sharing of instances between network segments may be technical constraints due to the nature of the telecommunications network 5G, but may also be requests from the management entity CSP relating to the communication service offering that the created network slice will allow it to offer.

The information comprising quality of service parameters allows the management entity CSP to transmit its requests with regard to the expected quality of service of the new network slice the creation of which is requested by the management entity CSP. This information will be used by the management entity NOP, for example, to decide on the quantity of hardware resources reserved to execute the virtualized network function instances, assuming that a greater number of hardware resources used improves the quality of service. These requested parameters may also influence the location of the virtualized network function instances. These choices made by the management entity NOP may be based on predefined templates or models to simplify the choice of options by the management entity NOP.

In other embodiments, the transmitted information may comprise information relating to the hardware resources on which the virtualized network function instances will run. Such requests may make it possible to guarantee a certain quality of service by constraining the power of the hardware resources used by the network slice to be created or else their location. Indeed, the location of some hardware resources may influence the quality of service obtained by the network slice for some virtualized network function instances, for example by decreasing the latency of some communications between functions.

In other embodiments, the management entity NSP responsible for providing network slices makes a choice from the set D of descriptions of network slices received from the management entity NOP and transmits the chosen subset of descriptions of network slices from the set of descriptions to the management entity CSP. This embodiment allows the management entity NSP to intervene in the choice of the network slice to be created. Other embodiments make it possible to achieve the same objective. In some embodiments, the management entity NSP will transmit, to the management entity CSP, a single description of a network slice chosen from the set D of descriptions of network slices defined by the management entity NOP. The management entity CSP will then validate the choice, made by the management entity NSP, of this unique description of a network slice to be created. If the management entity CSP does not validate this choice, the management entity NSP will transmit, to the management entity CSP, a second choice of description of a network slice chosen from the set D. The management entity NSP will be able to proceed in this way, by offering the management entity CSP a description of a network slice chosen from the set D of descriptions until the management entity CSP validates this choice. The management entity NSP is thereby able to organize, according to its own preferences, the descriptions of network slices able to be created following the request from the management entity CSP. The management entity NSP then submits, to the management entity CSP and in descending order of its preferences, the descriptions of network slices to be created, until the management entity CSP validates one of them. The preferences of both the management entity CSP and the management entity NSP are thereby involved in the choice of the description of the network slice to be created.

In another embodiment, the management entity CSP will receive a set D of descriptions of network slices, and will choose a subset of descriptions from the set D. This subset of descriptions represents the network slices that the management entity CSP may accept to be created so that the management entity CSP is able to provide its communication services. The management entity CSP will then transmit this subset to the management entity NSP, and it is the management entity NSP that will choose the description D2 of the network slice TR2 to be created from the subset of descriptions transmitted by the management entity CSP. Also in this embodiment, the two management entities CSP and NSP cooperate so as to arrive at the final choice of the network slice TR2 to be created, said choice taking into account their respective preferences since the management entity selects a subset from the set D of descriptions of network slices that are able to be created by the management entity NOP, and the management entity NSP chooses a single description from this subset of descriptions. In one embodiment that depends on the preceding embodiment, the management entity NSP, after having received a subset of descriptions chosen by the entity CSP, will choose a subset from this subset and transmit it to the management entity NOP. In this embodiment, it is the management entity NOP that ultimately chooses the description of the network slice to be created after having provided a set of possible descriptions, said set having been refined successively or alternately by the management entity CSP and the management entity NSP.

Lastly, it should be noted here that, in the present text, the term “module” may correspond equally to a software component or to a hardware component or to a set of software and hardware components, a software component itself corresponding to one or more computer programs or subroutines or, more generally, to any element of program able to implement a function or a set of functions such as described for the modules in question. In the same way, a hardware component corresponds to any element of a hardware assembly able to implement a function or a set of functions for the module in question (integrated circuit, chip card, memory card, etc.).

Although the present disclosure has been described with reference to one or more examples, workers skilled in the art will recognize that changes may be made in form and detail without departing from the scope of the disclosure and/or the appended claims.

1. A method for managing network slices in a telecommunications network comprising a management entity responsible for orchestrating virtualized network functions forming the network slices of the network, wherein the method comprises the following, carried out by said management entity:
selecting a set of virtualized network functions belonging to a first network slice; and
creating a second network slice comprising the selected virtualized network functions belonging to the first network slice (TR1).

2. The method for managing network slices as claimed in claim 1, wherein the method additionally comprises:
receiving, from a management entity responsible for providing network slices, a request to create a second network slice, the request comprising an identifier of the first network slice;
defining at least one description of a network slice, said at least one description referring to the selected virtualized network functions belonging to the first network slice;
transmitting, to the management entity, a set of previously defined descriptions of network slices;
receiving, from the management entity, a datum representative of a choice relating to the creation of the second network slice.

3. A method for managing network slices in a telecommunications network comprising a management entity responsible for providing network slices, wherein the method comprises the following, carried out by said management entity:
receiving, from a management entity responsible for providing communication services, a request to create a second network slice, the request comprising an identifier of a first network slice;
transmitting said creation request to a management entity responsible for orchestrating virtualized network functions;
receiving, from said management entity, a set of descriptions of network slices;
transmitting said set to the management entity;
receiving, from said management entity, a datum representative of a choice relating to the creation of the second network slice;
transmitting said datum to the management entity.

4. The method for managing network slices in a telecommunications network as claimed in claim 3, wherein the management entity makes a choice from the set of descriptions of network slices received from the management entity and then transmits the chosen subset of descriptions of network slices from the set of descriptions to the management entity.

5. A method for managing network slices in a telecommunications network comprising a management entity responsible for providing communication services, wherein the method comprises the following, carried out by said management entity:
transmitting, to a management entity responsible for providing network slices, a request to create a second network slice, the request comprising an identifier of a first network slice;
receiving, from the management entity, a set of descriptions of network slices;
choosing, from the previously received set of descriptions of network slices, the description of the second network slice;
transmitting, to the management entity, a datum representative of a choice relating to the creation of the second network slice.

6. The method for managing network slices in a telecommunications network as claimed in claim 5, wherein the management entity transmits, to the management entity, in relation to the request to create a second network slice comprising the identifier, information relating to the expected functionalities of the second network slice, said information comprising quality of service parameters and indications relating to the sharing of virtual network functions between the first network slice and the second network slice.

7. The method for managing network slices in a telecommunications network as claimed in claim 3, wherein the management entity receives, from the management entity, in relation to the request to create a second network slice comprising the identifier, information relating to the expected functionalities of the second network slice, said information comprising quality of service parameters and indications relating to the sharing of virtual network functions between the first network slice and the second network slice, and wherein the management entity transmits, to the management entity, said received information in addition to the request to create a second network slice comprising the identifier.

8. The method for managing network slices in a telecommunications network as claimed in claim 2, wherein the management entity receives, from the management entity, in relation to the request to create a second network slice comprising the identifier, information relating to the expected functionalities of the second network slice, said information comprising quality of service parameters and indications relating to the sharing of virtual network functions between the first network slice and the second network slice, and wherein the management entity selects a set of virtualized network functions belonging to the first network slice and defines at least one description of a network slice taking into account said received information.

9. A management entity responsible for orchestrating virtualized network functions forming the network slices of a telecommunications network, the management entity being configured to implement a method for managing network slices in the network, wherein the management entity comprises:
at least one processor; and
at least one non-transitory computer readable medium comprising instructions stored thereon which when executed by the at least one processor configure the management entity to:
receive, from a second management entity responsible for providing network slices, a request to create a second network slice, the request comprising an identifier of a first network slice;
select a set of virtualized network functions belonging to the first network slice;
define at least one description of a network slice, said at least one description referring to the selected virtualized network functions belonging to the first network slice;
transmit, to the management entity responsible for providing network slices, a set of previously defined descriptions of network slices;
receive, from the management entity responsible for providing network slices, a datum representative of a choice relating to the creation of the second network slice;
create a second network slice comprising the previously selected virtualized network functions belonging to the first network slice.

10. A management entity responsible for providing network slices in a telecommunications network, the entity being configured to implement a method for managing network slices in the network, wherein the management entity comprises:
at least one processor; and
at least one non-transitory computer readable medium comprising instructions stored thereon which when executed by the at least one processor configure the management entity to:
receive, from a management entity responsible for providing communication services, a request to create a second network slice, the request comprising an identifier of a first network slice;
transmit said creation request to a management entity responsible for orchestrating virtualized network functions;
receive, from said management entity, a set of descriptions of network slices;
transmit said set to the management entity.
receive, from said management entity, a datum representative of a choice relating to the creation of the second network slice;
transmit said datum to the management entity.

11. A management entity responsible for providing communication services in a telecommunications network, the entity being configured to implement a method for managing network slices in the network, wherein the management entity comprises:
at least one processor; and
at least one non-transitory computer readable medium comprising instructions stored thereon which when executed by the at least one processor configure the management entity to:
transmit, to a management entity responsible for providing network slices, a request to create a second network slice, the request comprising an identifier of a first network slice;
receive, from the management entity, a set of descriptions of network slices;
choose, from the previously received set of descriptions of network slices, the description of the second network slice;
transmit, to the management entity, a datum representative of a choice relating to the creation of the second network slice.

12. A non-transitory computer readable medium comprising a computer program stored thereon, which when executed by a processor of the management entity, carry out the method for managing network slices as claimed in claim 1.

13. A non-transitory computer readable medium comprising a computer program stored thereon which, when executed by a processor of the management entity, carry out the method for managing network slices as claimed in claim 3.

14. A non-transitory computer readable medium comprising a computer program stored thereon which, when executed by a processor of the management entity, carry out the method for managing network slices as claimed in claim 5.
